(19) United States
(12) Patent Application Publication
(10) Pub. No.: US 2007/0180369 A1
(43) Pub. Date: Aug. 2, 2007

(54) Method and apparatus for automatically formatting data based on a best match test result type

(76) Inventors: Carli Connally, Fort Collins, CO (US); Reid Hayhow, La Porte, CO (US)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 11/345,209

(22) Filed: Jan. 31, 2006

(51) Int. Cl. G06F 15/00

(52) U.S. Cl. 715/526

(57) ABSTRACT

In one embodiment, a computer implemented method for formatting data involves 1) automatically comparing data associated with a test result, the known data types being associated with test result types, to known data types to determine a best match test result type for the test result; and 2) automatically formatting the data associated with the test result in accord with one or more data formatting rules that are associated with the best match test result type. Other embodiments are also disclosed.

### BACKGROUND

When testing a circuit, test results may be logged in a “raw” format. Often, this raw format is 1) not accepted by the application programs that are used to analyze the test results, and 2) difficult for test engineers and others persons to comprehend.

As a result of the above difficulties that a raw data format presents, raw data is often converted to one or more other formats by, for example, rearranging, sorting, grouping, distilling and/or performing other operations on the data.

At times, different types of test results can be associated with different types of data. For example, in the case of circuit test, data may be parametric or functional. Because each of these data types needs to be handled differently during a data formatting operation, a data formatting system must have a way to identify these different data types and apply the appropriate formatting rules to them. One way to do this is by providing each type of test result with a name, and then using a look-up table to store associations between test result names and their corresponding data formatting rules. However, the use of a look-up table based on test result names can lead to performance, maintainability, stability and usability problems. Performance can be a problem because table look-ups in a large table can be time-consuming. Maintainability can be a problem because, when a new type of test result is added to a system, the test result must also be logged into the look-up table. Stability can be a problem because any sort of access to the look-up table leads to possible table corruption (e.g., as a result of an inadvertent and incorrect table update).

To mitigate the above maintainability and stability problems, a system may be provided with “default” formatting rules (i.e., rules that can be applied to any test result type that hasn't been specifically logged into a look-up table). However, the use of default rules can lead to usability problems, as default formatting rules may not present a close enough “fit” for the type(s) of data associated with a new test result, thereby raising the likelihood of data corruption and loss.

### SUMMARY OF THE INVENTION

In one embodiment, a computer implemented method for formatting data comprises 1) automatically comparing data associated within a test result to known data types, the known data types being associated with test result types, to determine a best match test result type for the test result; and 2) automatically formatting the data associated with the test result in accord with one or more data formatting rules that are associated with the best match test result type.

In another embodiment, apparatus for formatting data comprises computer readable code stored on computer readable media. The computer readable code comprises 1) code to automatically compare data associated with a test result to known data types, the known data types being associated with test result types, to determine a best match test result type for the test result; and 2) code to automatically format the data associated with the test result in accord with one or more data formatting rules that are associated with the best match test result type.

Other embodiments are also disclosed.

### BRIEF DESCRIPTION OF THE DRAWINGS

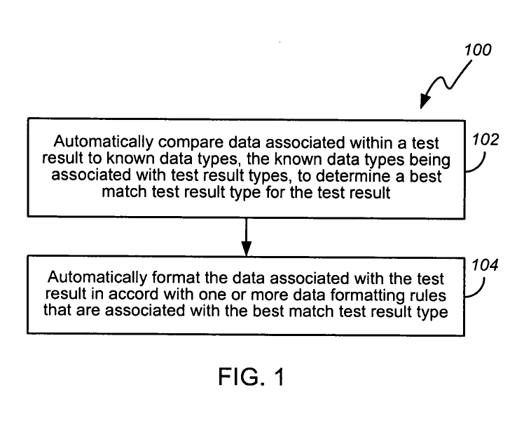

Illustrative embodiments of the invention are illustrated in the drawings, in which FIG. 1 illustrates an exemplary computer implemented method for formatting data.

### DETAILED DESCRIPTION

FIG. 1 illustrates an exemplary computer implemented method 100 for formatting data. The method comprises 1) automatically comparing data associated with a test result to known data types, the known data types being associated with test result types, to determine a best match test result type for the test result (see block 102); and 2) automatically formatting the data associated with the test result in accord with one or more data formatting rules that are associated with the best match test result type (see block 104).

In the case of circuit test, the known data types may comprise, for example, one or more parametric test data types, and one or more functional test data types. One of the parametric test data types may be defined by data comprising a test measurement and a test limit, and one of the functional test data types may be defined by data comprising vector information. Another one of the functional test data types may be defined by data comprising failing vectors. As defined herein, “vectors” and “vector information” are sets of data that are output from a DUT in response to sets of data inputs. Vectors are sometimes referred to as “patterns” or “cycles”.

After the data associated with a test result has been compared to known data types (e.g., parametric and functional data types), and a best match test result type has been determined, the data associated with the test result may be formatted in a number of ways.

In one embodiment, data is formatted by associating at least some of the data with a data object in memory, wherein the data object has an object type that corresponds to the best match test result type. In another embodiment, data is formatted by writing at least some of the data associated with a test result to a file. The data is written to the file in accord with a record structure corresponding to the best match test result type.

In yet another embodiment, data is formatted by first associating at least some of the data with a data object in memory, wherein the data object has an object type that corresponds to the best match test result type. The data associated with the data object is then retrieved from the memory and written to a file, in accord with a record structure corresponding to the best match test result type.

Typically, the method 100 will be used to format data associated with a plurality of test results. In this case, the method may perform its comparing and formatting actions for each of the test results.

Some testers, such as the 93000 SOC (System On a Chip) Series tester offered by Agilent Technologies, Inc., generate an ordered sequence of test results. For this and other testers, the method 100 may receive the ordered sequence of test results, and when a given one of the test results is received, the method may perform its comparing and formatting actions for the given one of the test results before sequentially performing its comparing and formatting actions for a next one of the test results.

Depending on its implementation, the method 100 can offer various advantages over other data formatting systems. For example, if enough data types can be anticipated, and formatting rules can be provided for them, then the method 100 is not limited to an ability to format only particular types of test results, and can instead format any type of test result comprised of known data types. This improves software maintainability, and increases data stability and usability (i.e., as a result of fewer chances for data corruption and loss). The method 100 also reduces the need for users to update a look-up table (that is, assuming that most or all data types that a test result might contain can be anticipated).

In one embodiment, the method 100 may be embodied in, and implemented by, computer readable code stored on computer readable media. The computer-readable media may include, for example, any number or mixture of fixed or removable media (such as one or more fixed disks, random access memories (RAMs), read-only memories (ROMs), or compact discs), at either a single location or distributed over a network. The computer readable code will typically comprise software, but could also comprise firmware or a programmed circuit.

What is claimed is:

1. A computer implemented method for formatting data, comprising:
automatically comparing data associated within a test result to known data types, the known data types being associated with test result types, to determine a best match test result type for the test result; and
automatically formatting the data associated with the test result in accord with one or more data formatting rules that are associated with the best match test result type.

2. The method of claim 1, wherein the test result is one of a plurality of test results, and wherein the method further comprises performing said comparing and formatting actions for each of the plurality of test results.

3. The method of claim 2, further comprising:
receiving the plurality of test results in an ordered sequence; and
when a given one of the test results is received, performing the comparing and formatting actions for the given one of the test results before sequentially performing the comparing and formatting actions for a next one of the test results.

4. The method of claim 1, wherein the known data types comprise:
at least one parametric test data type; and
at least one functional test data type.

5. The method of claim 4, wherein at least one of the parametric test data types is defined by data comprising a test measurement and a test limit.

6. The method of claim 4, wherein at least one of the functional test data types is defined by data comprising vector information.

7. The method of claim 4, wherein at least one of the functional test data types is defined by data comprising failing vectors.

8. The method of claim 1, wherein formatting the data associated with the test result comprises associating i) at least some of the data associated with the test result, with ii) a data object in memory, the data object having an object type corresponding to the best match test result type.

9. The method of claim 1, wherein formatting the data associated with the test result comprises writing at least some of the data associated with the test result to a file, in accord with a record structure corresponding to the best match test result type.

10. The method of claim 1, wherein formatting the data associated with the test result comprises:
associating i) at least some of the data associated with the test result, with ii) a data object in memory, the data object having an object type corresponding to the best match test result type; and then
retrieving the data associated with the data object from memory, and writing the retrieved data to a file, in accord with a record structure corresponding to the best match test result type.

11. Apparatus for formatting data, comprising:
computer readable media; and
computer readable code, stored on the computer readable media, including,
code to compare data associated with a test result to known data types, the known data types being associated with test result types, to determine a best match test result type for the test result; and
code to format the data associated with the test result in accord with one or more data formatting rules that are associated with the best match test result type.

12. The apparatus of claim 11, wherein the test result is one of a plurality of test results, and wherein the apparatus further comprises code to perform said comparing and formatting actions for each of the plurality of test results.

13. The apparatus of claim 12, further comprising:
code to receive the plurality of test results in an ordered sequence; and
code to, when a given one of the test results is received, perform the comparing and formatting actions for the given one of the test results before sequentially performing the comparing and formatting actions for a next one of the test results.

14. The apparatus of claim 11, wherein the known data types comprise:
at least one parametric test data type; and
at least one functional test data type.

15. The apparatus of claim 14, wherein at least one of the parametric test data types is defined by data comprising a test measurement and a test limit.

16. The apparatus of claim 14, wherein at least one of the functional test data types is defined by data comprising vector information.

17. The apparatus of claim 14, wherein at least one of the functional test data types is defined by data comprising failing vectors.

18. The apparatus of claim 11, wherein formatting the data associated with the test result comprises associating i) at least some of the data associated with the test result, with ii) a data object in memory, the data object having an object type corresponding to the best match test result type.

19. The apparatus of claim 11, wherein formatting the data associated with the test result comprises writing at least some of the data associated with the test result to a file, in accord with a record structure corresponding to the best match test result type.

20. The apparatus of claim 11, wherein formatting the data associated with the test result comprises:
associating i) at least some of the data associated with the test result, with ii) a data object in memory, the data object having an object type corresponding to the best match test result type; and then
retrieving the data associated with the data object from memory, and writing the retrieved data to a file, in accord with a record structure corresponding to the best match test result type.
